(19) United States
(12) Patent Application Publication
(10) Pub. No.: US 2024/0420506 A1
(43) Pub. Date: Dec. 19, 2024

(54) MOTION DETERMINATION APPARATUS, MOTION DETERMINATION METHOD, AND NON-TRANSITORY COMPUTER READABLE MEDIUM

(71) Applicant: NEC Corporation, Minato-ku, Tokyo (JP)

(72) Inventors: Noboru YOSHIDA, Tokyo (JP); Ryo Kawai, Tokyo (JP); Jianquan Liu, Tokyo (JP)

(73) Assignee: NEC Corporation, Minato-ku, Tokyo (JP)

(21) Appl. No.: 18/703,754

(22) PCT Filed: Mar. 2, 2022
(86) PCT No.: PCT/JP2022/008857

§ 371 Date: Apr. 23, 2024

(51) Int. Cl. G06V 40/20; G06V 20/40; G06V 20/52; G06V 40/10

(52) U.S. Cl. CPC G06V 40/20; G06V 20/46; G06V 20/52; G06V 40/10; G06V 2201/08

(57) ABSTRACT

Provided is a motion determination apparatus and the like that can determine a motion of a person faster and more efficiently. A motion determination apparatus includes a position specifying means for specifying a position of a person from acquired image data, a motion specifying means for specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person, and a determination means for determining whether the specified characteristic motion is in a predetermined order.

### TECHNICAL FIELD

The present disclosure relates to a motion determination apparatus, a motion determination method, and a non-transitory computer readable medium.

### BACKGROUND ART

In facilities such as self-fueling stations and coin-parking, a user is required to perform a motion in a predetermined procedure from the viewpoint of safety, efficiency, or the like. There is a technique for monitoring whether a user is performing a motion in a correct procedure.

For example, Patent Literature 1 discloses a self-fueling system including a means for imaging a user who performs fueling, a means for determining whether the behavior of the user is abnormal, normal, or unknown based on the imaged image, a means for stopping or prohibiting the fueling when the behavior of the user for each fueling process is determined to be abnormal or unknown, and a management terminal that displays an image that serves as a basis for the determination.

### CITATION LIST

### Patent Literature

Patent Literature 1: International Patent Publication No. WO2021/117346

### SUMMARY OF INVENTION

### Technical Problem

There is a demand for a motion determination capable of determining a motion of a person faster and more efficiently.

In view of the above-described problems, an object of the present disclosure is to provide a motion determination apparatus, a motion determination method, and a non-transitory computer readable medium capable of determining a motion of a person faster and more efficiently.

### Solution to Problem

According to one aspect of the present disclosure, there is provided a motion determination apparatus including:
a position specifying means for specifying a position of a person from acquired image data;
a motion specifying means for specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
a determination means for determining whether the specified characteristic motion is in a predetermined order.

According to one aspect of the present disclosure, there is provided a motion determination method including:
specifying a position of a person from acquired image data;
specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
determining whether the specified characteristic motion is in a predetermined order.

According to one aspect of the present disclosure, there is provided a non-transitory computer readable medium storing a program for causing a computer to execute:
a process of specifying a position of a person from acquired image data;
a process of specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
a process of determining whether the specified characteristic motion is in a predetermined order.

### Advantageous Effects of Invention

According to the present disclosure, it is possible to provide a motion determination apparatus, a motion determination method, and a non-transitory computer readable medium capable of determining a motion of a person faster and more efficiently.

### BRIEF DESCRIPTION OF DRAWINGS

FIG. 1 is a block diagram illustrating a configuration of a motion determination apparatus according to a first example embodiment.

FIG. 2 is a flowchart illustrating a flow of a motion determination method according to the first example embodiment.

FIG. 3 is a diagram illustrating an overall configuration of a motion determination system according to a second example embodiment.

FIG. 4 is a block diagram illustrating configurations of a server and a terminal device according to the second example embodiment.

FIG. 5 is a diagram illustrating skeleton information extracted from a frame image included in video data according to the second example embodiment.

FIG. 6 is a flowchart illustrating a flow of a video data transmission method by the terminal device according to the second example embodiment.

FIG. 7 is a flowchart illustrating a flow of a registration motion ID and a registration motion sequence registration method by the server according to the second example embodiment.

FIG. 8 is a diagram for explaining a registration motion according to the second example embodiment.

FIG. 9 is a diagram for explaining a normal motion sequence according to the second example embodiment.

FIG. 10 is a diagram for describing an attention motion sequence according to the second example embodiment.

FIG. 11 is a flowchart illustrating a flow of a motion determination method by the server according to the second example embodiment.

FIG. 12 is a block diagram illustrating a hardware configuration example of the motion determination apparatus 100 or the like.

### EXAMPLE EMBODIMENT

Hereinafter, the present disclosure will be described through example embodiments, but the disclosure according to the claims is not limited to the following example embodiments. In addition, not all the configurations described in the example embodiment are essential as means for solving the problem. In the drawings, the same elements are denoted by the same reference numerals, and repeated description is omitted as necessary.

### First Example Embodiment

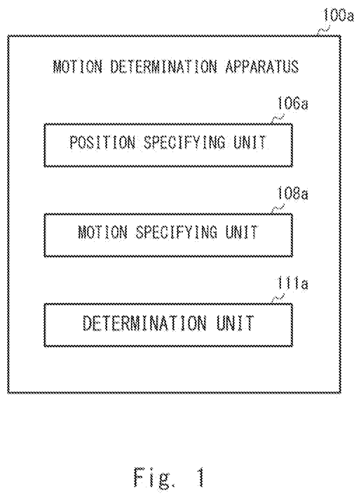

FIG. 1 is a block diagram illustrating a configuration of a motion determination apparatus 100a according to a first example embodiment. The motion determination apparatus 100a is a computer system that specifies a plurality of motions by the user and determines whether the plurality of motions is performed in a predetermined order. The motion determination apparatus 100a includes a position specifying unit 106a, a motion specifying unit 108a, and a determination unit 111a.

The motion determination apparatus 100a includes the position specifying unit 106a that specifies a position of a person from acquired image data, the motion specifying unit 108a that specifies a first characteristic motion by analyzing a motion of the person in the image in accordance with a first characteristic motion pattern associated with a first position of the specified person, and specifies a second characteristic motion by analyzing a motion of the person in the image in accordance with a second characteristic motion pattern associated with a second position of the specified person, and the determination unit 111a that determines whether the specified characteristic motion is in a predetermined order.

The position specifying unit 106a is also referred to as a position specifying means. The position specifying unit 106a can specify the position of the person for each acquired image frame. The position of the person may include a three-dimensional position (for example, it is within a predetermined distance from a certain device or a latitude and longitude of a foot of a person) in a world coordinate system and the position of the person in the image. The position of the person in the image can be defined as a position related to the motion of the person, for example, a position of a hand or a position of a leg within several pixels from a certain object. The position in the image may also define a three-dimensional position in real space including the depth as viewed from the camera.

The motion specifying unit 108a is also referred to as a motion specifying means. The motion specifying unit 108a can specify at least two different characteristic motions of the person according to the stored characteristic motion pattern associated with the specific position. The “first characteristic motion pattern associated with the first position” may be, for example, a pattern including a posture or a motion in which a person touches a static elimination pad near a fuel filler at a gas station. The “second characteristic motion pattern associated with the second position” may be, for example, a pattern including a motion of removing a cap of a fuel filler hole of a vehicle or a posture or a motion of a person holding a fuel filler nozzle of a fuel filler at a gas station. These motion patterns may be stored as normal motion patterns associated with positions.

The determination unit 111a is also referred to as a determination means. The determination unit 111a determines whether the characteristic motion has been performed in the correct order. For example, assuming that the second characteristic motion is performed after the first characteristic motion in the correct order, when the motion specifying unit 108a specifies the second characteristic motion after the first characteristic motion, the determination unit 111a determines that the order is correct. Meanwhile, when the motion specifying unit 108a specifies the first characteristic motion after the second characteristic motion or specifies the second characteristic motion without specifying the first characteristic motion, the determination unit 111a determines that the order is incorrect.

Note that, in some example embodiments, the motion determination apparatus further includes an output unit that outputs an alert. The output unit can output an alert when the determination unit 111a determines the incorrect order. The alert may be displayed on a display unit or may be output as a voice from a speaker. In another example embodiment, the motion determination apparatus includes a processing control unit that controls the fuel filler so as to stop the fueling.

Furthermore, in some example embodiments, the motion determination apparatus includes a storage unit that stores a characteristic motion pattern or the like associated with the predetermined order and position described above.

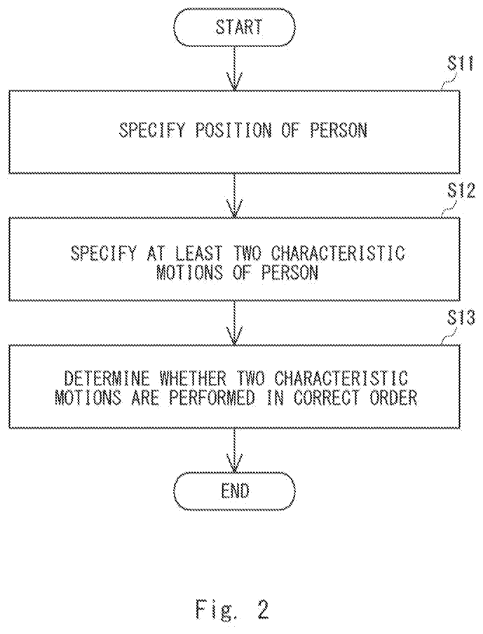

FIG. 2 is a flowchart illustrating a flow of the motion determination method according to the first example embodiment. First, the position specifying unit 106a specifies the position of the person from the acquired image data (S11).

The motion specifying unit 108a specifies the first characteristic motion by analyzing the motion of the person in the image according to the first characteristic motion pattern associated with the first position of the specified person, and specifies the second characteristic motion by analyzing the motion of the person in the image according to the second characteristic motion pattern associated with the second position of the specified person (S12).

The determination unit 111a determines whether the specified characteristic motion is in a predetermined order (S13).

As described above, according to the first example embodiment, the motion determination apparatus 100a can quickly and efficiently determine whether the order of the user's motion is correct by specifying the user's motion according to the pre-registered characteristic motion pattern. In addition, by specifying the motion of the person after specifying the position, it is possible to prevent erroneous detection of a similar motion performed at a different position and to improve the accuracy of specifying the motion and the accuracy of determining the order.

### Second Example Embodiment

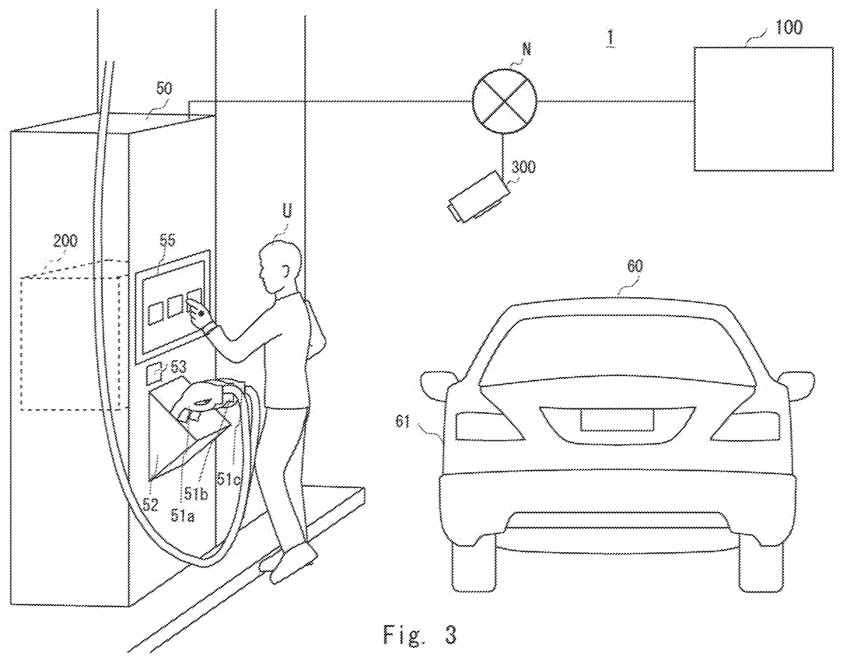

FIG. 3 is a diagram illustrating an overall configuration of a motion determination system 1 according to a second example embodiment. The motion determination system 1 is a computer system that monitors the motion of a user U who has visited a fuel filler 50 of the gas station, determines whether the motion has been performed in a predetermined order, and executes predetermined processing according to a determination result.

As an example, a normal flow in a case where the user U supplies fuel to the vehicle 60 with the fuel filler 50 of the gas station is as follows.

(1) First, the user U gets on the vehicle 60, stops at the gas station on the side of the fuel filler 50, and stops the engine.

(2) The user U opens the fuel filler hole of the vehicle by operating a predetermined button in the vehicle, opens the door, and goes out of the vehicle.

(3) The user U operates the display panel of the fuel filler 50 to select a payment method (for example, cash or credit card), a desired oil type (for example, high-octane, regular, and light oil), and a fueling condition (for example, full tank, fixed amount).

(4) The user U touches a static elimination pad (also referred to as a static elimination sheet) with his/her hand.

(5) The user U opens the cap in the fuel filler hole 61 of the vehicle opened in the above (2) by manually rotating the cap.

(6) The user U places the cap at a predetermined location (for example, behind the fuel filler hole 61, a predetermined location of the fuel filler, or the like).

(7) The user U grips any one of fuel filler nozzles 51a to 51c corresponding to the selected oil type (for example, high-octane, regular, light oil, and the like) and inserts the fuel filler nozzle into the fuel filler hole.

(8) The user U performs the fueling by holding the trigger of the fuel filler nozzle. Since a sensor is attached to the nozzle, the fueling is automatically terminated when the nozzle is full.

(9) After the fueling is completed, the user U removes the fuel filler nozzle from the fuel filler hole 61 and returns the fuel filler nozzle to a predetermined attachment place of the fuel filler.

(10) The user U takes the receipt issued from the fuel filler 50 or a checkout device (not illustrated).

(11) The user U removes the cap placed above, closes the hole of the fuel filler hole 61 with the cap, and closes the fuel filler hole 61.

Here, as illustrated in FIG. 3, the motion determination system 1 includes a server 100, a terminal device 200 in the fuel filler 50, and one or more cameras 300. The server 100 and the terminal device 200 are communicably connected via a network N. The network N may be wired or wireless.

The camera 300 is a camera that photographs the user U standing in front of the fuel filler 50 and monitors the user U. The camera 300 is disposed at a position and an angle at which at least a part of the body of the user U standing in front of the fuel filler 50 can be photographed. The camera 300 may be a plurality of cameras, one of which is disposed at a position and an angle at which the vehicle in front of the fuel filler 50 can be photographed. Although the vehicle is illustrated in FIG. 3, the present example embodiment can also be applied to various moving manual operations such as a motorcycle, a truck, and a bus.

The terminal device 200 is a computer including a memory that controls the fuel filler 50, a processor, and the like. The terminal device 200 acquires video data from the camera 300 and transmits the video data to the server 100 via the network N. In addition, the terminal device 200 receives warning information indicating that the server 100 has specified the attention motion of the user U, and outputs the warning information using the display unit 203 or the voice output unit 204 (display panel 55 or speaker of the fuel filler 50). The display panel 55 of the fuel filler 50 may be installed at a position where the user U or a store staff can easily visually recognize. The speaker (not illustrated) of the fuel filler 50 may be installed at a position where the user U or a store staff can easily hear the voice. The terminal device 200 receives a selection input in which the user U performs a touch operation on the display panel 55 of the fuel filler 50, and executes predetermined processing on each hardware of the fuel filler.

The server 100 is a computer that specifies the motion, the motion sequence, and the attention motion related to the fuel filler 50 by the user U based on the video data received from the terminal device 200. The server 100 detects the motion sequence of the user, determines whether the motion is in the correct order, and transmits the determination result to the terminal device 200 via the network N. When detecting the attention motion (for example, an incorrect order of motion or dangerous unit motion), the server 100 transmits warning information to the terminal device 200 via the network N.

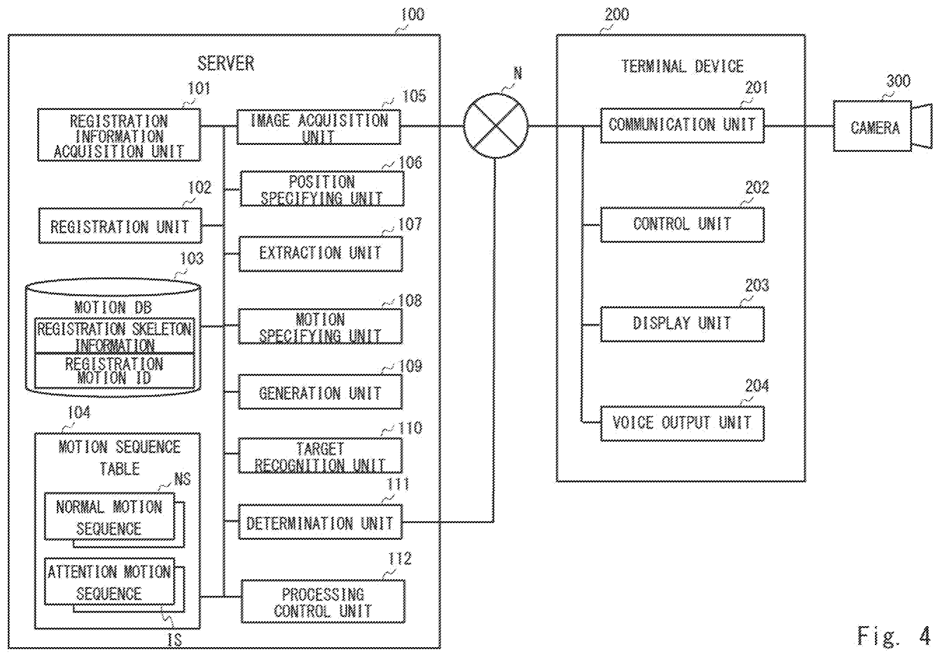

FIG. 4 is a block diagram illustrating a configuration of the server 100 and the terminal device 200 according to the second example embodiment. The server 100 is also referred to as a motion determination apparatus.

### (Terminal Device 200)

The terminal device 200 includes a communication unit 201, a control unit 202, a display unit 203, and a voice output unit 204. The terminal device 200 controls the fuel filler 50, acquires the video data from the camera 300, and appropriately transmits the video data to the server 100.

The communication unit 201 is also referred to as a communication means. The communication unit 201 is a communication interface with the network N. Furthermore, the communication unit 201 is connected to the camera 300, and acquires video data from the camera 300 at predetermined time intervals.

The control unit 202 is also referred to as a control means. The control unit 202 controls hardware included in the terminal device 200 and the fuel filler 50. The control unit 202 controls, for example, the display panel 55 (touch panel) of the fuel filler 50, the fuel filler nozzle 51, the camera 300, a receipt issuing machine (not illustrated), and the like. For example, when detecting a start trigger, the control unit 202 starts to transmit the video data acquired from the camera 300 to the server 100. The detection of the start trigger refers to “detecting that the user's vehicle visits the fuel filler” described above. Furthermore, for example, in a case where an end trigger is detected, the control unit 202 ends the transmission of the video data acquired from the camera 300 to the server 100. The detection of the end trigger refers to “detecting that the vehicle of the user U has left the fuel filler 50” described above.

Then, when the communication unit 201 receives warning information regarding the attentional motion or the motion order of the user U from the server 100, the control unit 202 displays the warning information on the display unit 203. Furthermore, the control unit 202 may cause the voice output unit 204 to output warning information.

The display unit 203 is a display panel. The voice output unit 204 is a voice output device including a speaker.

### (Server 100)

The server 100 includes a registration information acquisition unit 101, a registration unit 102, a motion DB 103, a motion sequence table 104, an image acquisition unit 105, a position specifying unit 106, an extraction unit 107, a motion specifying unit 108, a generation unit 109, a target recognition unit 110, a determination unit 111, and a processing control unit 112.

The registration information acquisition unit 101 is also referred to as a registration information acquisition means. The registration information acquisition unit 101 acquires a plurality of registration video data in response to a motion registration request from the terminal device 200 or by an operation of an administrator of the server 100. In the second example embodiment, each registration video data is video data indicating an individual motion (for example, a motion of operating the fuel filler, a motion of touching the static elimination pad, and the like) included in the normal motion or the attention motion of the person. In the second example embodiment, the registration video data is a moving image including a plurality of frame images, but may be a still image (one frame image).

In addition, the registration information acquisition unit 101 acquires the plurality of registration motion IDs and the information about the time-series order in which the motion is performed in the series of acts in response to the sequence registration request from the terminal device 200 or the operation of the administrator of the server 100.

The registration information acquisition unit 101 supplies the acquired information to the registration unit 102.

The registration unit 102 is also referred to as a registration means. First, the registration unit 102 executes motion registration processing in response to the motion registration request. Specifically, the registration unit 102 supplies the registration video data to the extraction unit 107 to be described later, and acquires skeleton information extracted from the registration video data from the extraction unit 107 as registration skeleton information. Then, the registration unit 102 registers the acquired registration skeleton information in the motion DB 103 in association with the registration motion ID.

Next, the registration unit 102 executes sequence registration processing in response to the sequence registration request. Specifically, the registration unit 102 generates the registration motion sequence by arranging the registration motion IDs in time series based on the information about the time-series order. At this time, in a case where the sequence registration request is related to the normal motion, the registration unit 102 registers the generated registration motion sequence in the motion sequence table 104 as the normal motion sequence NS. Meanwhile, when the sequence registration request relates to the attention motion, the registration unit 102 registers the generated registration motion sequence in the motion sequence table 104 as the attention motion sequence IS. Examples of the attention motion include, but are not limited to, a motion of inhaling tobacco and a motion of lighting with a lighter.

The motion DB 103 is a storage device that stores the registration skeleton information corresponding to each motion included in the normal motion in association with the registration motion ID. In addition, the motion DB 103 may store registration skeleton information corresponding to each motion included in the attention motion in association with the registration motion ID.

The motion sequence table 104 stores a normal motion sequence NS and an attention motion sequence IS. In the second example embodiment, the motion sequence table 104 stores a plurality of normal motion sequences NS and a plurality of attention motion sequences IS. The motion DB and the motion sequence table may be simply referred to as a storage unit.

The image acquisition unit 105 is also referred to as an image acquisition unit. The image acquisition unit 105 acquires the video data captured by the camera 300 from the terminal device 200 when the fuel filler 50 is operated. That is, the image acquisition unit 105 acquires the video data in response to the detection of the start trigger. The image acquisition unit 105 supplies the frame image included in the acquired video data to the position specifying unit 106, the extraction unit 107, the target recognition unit 110, and the like.

The position specifying unit 106 is also referred to as a position specifying means. The position specifying unit 106 specifies the position of the person from the image data acquired by the image acquisition unit 105. The position specifying unit 106 specifies the position (for example, a position where a person is present near the static elimination pad of the fuel filler, the fuel filler nozzle, the fuel filler hole of a vehicle, or the like) of the person in the store. When a distance between the position of the hand of the person recognized by the known image recognition technology and an object (for example, the static elimination pad of the fuel filler, the fuel filler nozzle, the fuel filler hole of a vehicle, and the like) is within a predetermined distance (for example, within a few pixels in the image), the person can be specified as being at the position of the object. Furthermore, in another example, for example, since an angle of view of the camera is fixed to the store (for example, a gas station), a correspondence relationship (for example, a relatively distant positional relationship such as positions of the fuel filler and the fuel filler hole of the vehicle) between the position of the person in the captured image and the position of the person in the store can be defined in advance, and the position in the image can be converted to the position in the store based on the definition. More specifically, in a first step, a height, an azimuth angle, and an elevation angle at which the camera that captures the image of the inside of the store is installed, and a focal length (hereinafter referred to as a camera parameter) of the camera are estimated from the captured image using an existing technology. These may be actually measured or a specification may be referred to. In a second step, the position where the foot of the person is located is converted from two-dimensional coordinates (hereinafter referred to as image coordinates) on the image to three-dimensional coordinates (hereinafter referred to as world coordinates) in the real world based on the camera parameters using the existing technology. The conversion from the image coordinates to the world coordinates is usually not uniquely determined, but the conversion can be uniquely performed by fixing the coordinate value in the height direction of the foot to zero, for example. In a third step, a map in the three-dimensional transportation means is prepared in advance, and the world coordinates obtained in the second step are projected onto the map, whereby the position of the person in the store can be specified.

The extraction unit 107 is also referred to as an extraction means. The extraction unit 107 detects an image region (body region) of the body of the person from the frame image included in the video data, and extracts the image region as a body image (for example, cutting out). Then, the extraction unit 107 extracts skeleton information of at least a part of the body of the person based on features such as joints of the person recognized in the body image using a skeleton estimation technique using machine learning. The skeleton information is information including a “key point” that is a characteristic point such as a joint and a “bone (bone link)” indicating a link between the key points. The extraction unit 107 may use, for example, a skeleton estimation technique such as OpenPose. The extraction unit 107 supplies the extracted skeleton information to the motion specifying unit 108.

The motion specifying unit 108 is also referred to as a motion specifying means. The motion specifying unit 108 converts the skeleton information extracted from the video data acquired at the time of operation into the motion ID using the motion DB 103. As a result, the motion specifying unit 108 specifies the motion of the person. Specifically, first, the motion specifying unit 108 specifies, from the registration skeleton information registered in the motion DB 103, registration skeleton information having a similarity to the skeleton information extracted by the extraction unit 107 equal to or more than a predetermined threshold. Then, the motion specifying unit 108 specifies the registration motion ID associated with the specified registration skeleton information as the motion ID corresponding to the person included in the acquired frame image.

The motion specifying unit 108 specifies the first characteristic motion by analyzing the motion of the person in the image according to the motion pattern associated with the first position of the specified person, and then specifies the second characteristic motion by analyzing the motion of the person in the image according to the motion pattern associated with the second position of the specified person. For example, the first characteristic motion may be a motion in which a person touches the static elimination pad associated with the position of the static elimination pad. The second characteristic motion may be a motion in which a person grips the fuel filler nozzle associated with the position of the fuel filler nozzle. In another example, another characteristic motion may be a motion in which a person inserts a fuel filler nozzle into a fuel filler hole associated with a position of the fuel filler hole of the vehicle.

Here, the motion specifying unit 108 may specify one motion ID based on skeleton information corresponding to one frame image, or may specify one motion ID based on time-series data of skeleton information corresponding to each of a plurality of frame images. When specifying one motion ID using a plurality of frame images, the motion specifying unit 108 may extract only skeleton information having a large movement and collate the extracted skeleton information with registration skeleton information in the motion DB 103. Extracting only skeleton information having a large movement may mean extracting skeleton information in which a difference between pieces of skeleton information of different frame images included within a predetermined period is a predetermined amount or more. Since such a small amount of collation is sufficient, the calculation load can be reduced, and the amount of registration skeleton information is also small. In addition, since only skeleton information having a large movement is used as the collation target although the duration of the motion differs depending on the person, robustness can be given to the motion specification.

Note that, in addition to the above-described method, various methods can be considered for specifying the motion ID. For example, there is a method of estimating the motion ID from target video data using a motion estimation model in which video data correctly assigned by the motion ID is learned as learning data. However, it is difficult to collect the learning data, and the cost is high. Meanwhile, in the second example embodiment, the skeleton information is used for estimating the motion ID, and is compared with the skeleton information registered in advance using the motion DB 103. Therefore, in the second example embodiment, the server 100 can more easily specify the motion ID.

The generation unit 109 is also referred to as a generation means. The generation unit 109 generates a motion sequence based on the plurality of motion IDs specified by the motion specifying unit 108. The motion sequence is configured to include a plurality of motion IDs in time series. The generation unit 109 supplies the generated motion sequence to the determination unit 111.

The target recognition unit 110 is also called target recognition means. The target recognition unit 110 can also recognize an object, particularly a moving target (for example, a vehicle or a person) from the acquired image data by a known image recognition technology or the like. The target recognition unit 110 can recognize a vehicle entering the angle of view captured by the camera 300, and can also recognize the fuel filler hole of the opened vehicle. The target recognition unit 110 can also specify the position of the vehicle and the position of the fuel filler hole in cooperation with the position specifying unit 106 described above.

In another example embodiment, a marker or the like that can be recognized by an image is incorporated at the distal end of the fuel filler nozzle, so that the target recognition unit 110 can recognize that the distal end of the fuel filler nozzle has been inserted into the fuel filler hole of the vehicle.

Furthermore, in another example embodiment, in a case where there is a plurality of persons in the image, the target recognition unit 110 can recognize each person and determine whether the person who touches the static elimination pad is feeding oil.

In a case where a person who touches the static elimination pad is feeding oil, the determination unit described later can determine that the motion is correct, and conversely, in a case where the person who touches the static elimination pad is different from the person who grips the fuel filler nozzle, the determination unit can determine that the motion is incorrect. That is, the target recognition unit 110 can acquire the motion history of each person in cooperation with the extraction unit 107, the motion specifying unit 108, and the generation unit 109 described above.

The determination unit 111 is also referred to as a determination means. The determination unit 111 determines whether the generated motion sequence matches (corresponds to) any one of normal motion sequences NS registered in the motion sequence table 104. For example, the determination unit 111 determines whether the first characteristic motion and the second characteristic motion described above are performed in the correct order (that is, whether the second characteristic motion is performed after the first characteristic motion).

In some example embodiments, the target recognition unit 110 can recognize a vehicle present in a predetermined stop region in the image, and the determination unit 111 can determine whether the vehicle is stopped at the vehicle stop position. When the determination unit detects that the person has performed the characteristic motion, it is possible to determine whether the vehicle is stopped at the vehicle stop position.

The processing control unit 112 is an example of the processing control unit 21 described above. In a case where it is determined that the generated motion sequence does not correspond to any of the normal motion sequences NS, the processing control unit 112 outputs warning information to the terminal device 200. In this case, the processing control unit 112 is also referred to as an output means. For example, in the example of the gas station illustrated in FIG. 3, in order to remove static electricity of the human body, the user U grasps the fuel filler nozzle 51 after touching the static elimination pad 53 in the correct order. In addition, as described above in the normal flow in the case of fueling the vehicle, the motion order of the user U can be arbitrarily set as the normal motion sequence.

In some example embodiments, the storage unit stores a time limit of each step in which the unit characteristic motion (for example, the motion of touching the static elimination pad, the motion of gripping the fuel filler nozzle, and the like) is performed, the determination unit 111 determines whether the time limit has been exceeded in each step, and the output means outputs the determination information at a time point when the time limit has been exceeded.

In some example embodiments, the storage unit may also store the time limit of each step, the determination unit may also determine whether the time limit has been exceeded in each step, and the output means may output the determination information at the time point when the time limit has been exceeded.

When determining that the motion sequence does not correspond to any of the normal motion sequences NS, the determination unit 111 may determine which one of the attention motion sequences the motion sequence corresponds to. In this case, the processing control unit 112 may output information determined in advance according to the type of the attention motion sequence to the terminal device 200. As an example, a display mode (font, color, thickness, blinking, or the like of characters) in a case where the warning information is displayed may be changed according to the type of the attention motion sequence, or a volume or a sound itself in a case where the warning information is output by sound may be changed. As a result, the user U or the store staff can recognize the content of the attention motion and quickly and appropriately deal with the attention motion. In addition, the processing control unit 112 may record the time, the place, and the video at which the attention motion is performed as the history information together with the information about the type of the attention motion sequence. As a result, the store staff can recognize the content of the attention motion and appropriately take preventive measures against the attention motion.

In some example embodiments, when the person does not touch the static elimination pad, the processing control unit 112 can prevent a fuel filler button for starting fueling from reacting (for example, on the display panel). That is, when the person does not touch the static elimination pad, the processing control unit 112 can restrict the activation of the fuel filler button for starting the fueling.

In some example embodiments, the processing control unit 112 can prevent the trigger of the fuel filler nozzle for starting fueling from reacting when the person does not touch the static elimination pad. That is, when the person does not touch the static elimination pad, the processing control unit 112 can restrict the activation of the trigger of the fuel filler nozzle for starting the fueling.

In another example embodiment, when the motion specifying unit 108 specifies an attention motion in which a person or another person around the person is smoking, the processing control unit 112 may stop the fueling from the fuel filler to the fuel filler nozzle, or may notify the store staff of the attention motion.

In still another example embodiment, when the motion specifying unit 108 specifies one characteristic motion of the person, the processing control unit 112 may cause the display panel 55 to display the next motion in the normal motion sequence and transmit the next motion to the person.

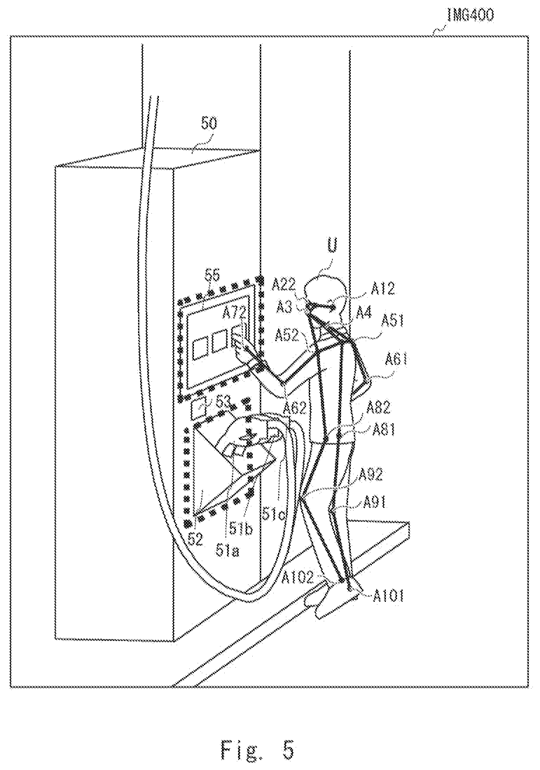

FIG. 5 is a diagram illustrating skeleton information extracted from a frame image IMG400 included in the video data according to the second example embodiment. The frame image 400 is an image obtained by photographing the user U who performs a touch operation on the display panel 55 of the fuel filler 50 from the side. An image region of the entire body of the user U is included. In addition, the skeleton information illustrated in FIG. 5 includes a plurality of key points and a plurality of bones detected from the entire body. As an example, in FIG. 5, as key points, left ear A12, left eye A22, nose A3, neck A4, right shoulder A51, left shoulder A52, right elbow A61, left elbow A62, left hand A72, right waist A81, left waist A82, right knee A91, left knee A92, right foot A101, and left foot A102 are detected.

The server 100 compares such skeleton information with registration skeleton information corresponding to the entire body, and determines whether the skeleton information and the registration skeleton information are similar to each other, thereby specifying each motion. For example, in specifying the fueling motion, it is important whether a hand of a person approaches a predetermined object (for example, a static elimination pad, a fuel filler nozzle, a fuel filler hole of a vehicle, and the like), and in the motion of “taking out the fuel filler nozzle from the attachment portion” or “inserting the fuel filler nozzle into the fuel filling hole of the vehicle”, the positions of the right hand and the left hand in the frame image 400 are important. Therefore, the server 100 may weight the positions of the right hand A71 and the left hand A72 to calculate the similarity. In addition to the right hand A71 and the left hand A72, the server 100 may weight the right shoulder A51, the left shoulder A52, the right elbow A61, and the left elbow A62 to calculate the similarity.

Furthermore, at the time of specifying each motion, the object (for example, the fuel filler nozzle, the static elimination pad, and the vehicle) may be recognized from the image. Furthermore, the position of the person can be specified from the image before the motion is specified.

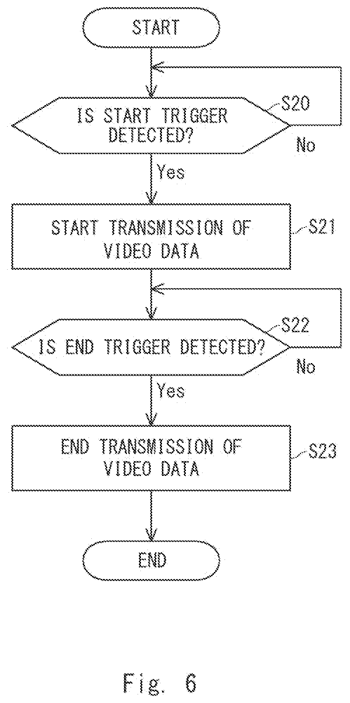

FIG. 6 is a flowchart illustrating a flow of a video data transmission method by the terminal device 200 according to the second example embodiment. First, the control unit 202 of the terminal device 200 determines whether the start trigger is detected (S20). When determining that the start trigger is detected (Yes in S20), the control unit 202 starts transmission of the video data acquired from the camera 300 to the server 100 (S21). Meanwhile, when not determining that the start trigger is detected (No in S20), the control unit 202 repeats the processing illustrated in S20.

Next, the control unit 202 of the terminal device 200 determines whether the end trigger is detected (S22). When determining that the end trigger is detected (Yes in S22), the control unit 202 ends the transmission of the video data acquired from the camera 300 to the server 100 (S23). Meanwhile, when determining that the end trigger is not detected (No in S22), the control unit 202 repeats the processing illustrated in S22 while executing the transmission of the video data.

As described above, by limiting a transmission period of the video data to a period between a predetermined start trigger and a predetermined end trigger, the amount of communication data can be minimized. In addition, since the motion specifying processing in the server 100 can be omitted outside the period, calculation resources can be saved.

In another example embodiment, the movement of the person may be tracked, but the tracking data may be discarded when the person shown in the image is framed out. As a result, it is possible to suppress resource compression.

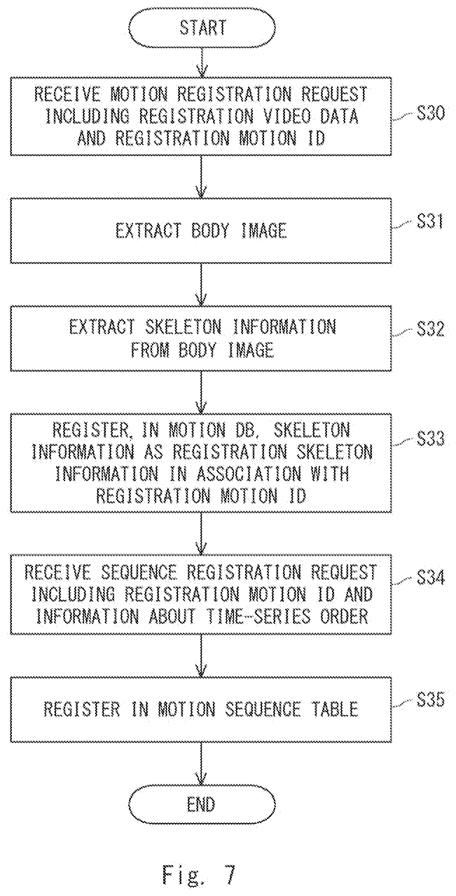

FIG. 7 is a flowchart illustrating a flow of the registration motion ID and a registration motion sequence registration method by the server 100 according to the second example embodiment. First, the registration information acquisition unit 101 of the server 100 receives the motion registration request including the registration video data and the registration motion ID from the terminal device 200 (S30). Next, the registration unit 102 supplies the registration video data to the extraction unit 107. When obtaining the registration video data, extraction unit 107 extracts the body image from the frame image included in the registration video data (S31). Next, the extraction unit 107 extracts skeleton information from the body image (S32). Next, the registration unit 102 acquires skeleton information from the extraction unit 107, and registers, in the motion DB 103, the acquired skeleton information as registration skeleton information in association with the registration motion ID (S33). Note that the registration unit 102 may set all pieces of skeleton information extracted from the body image as registration skeleton information, or may set only some pieces of skeleton information (for example, skeleton information of shoulder, elbow, and hand) as registration skeleton information.

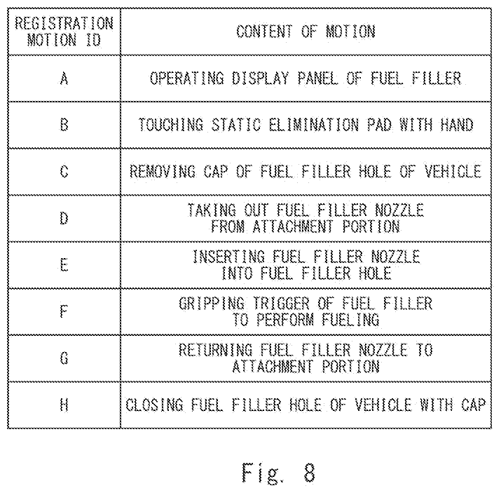

FIG. 8 is a diagram for describing the registration motion according to the second example embodiment. As an example, registration skeleton information of eight registration motions having registration motion IDs of “A” to “H” may be stored in the motion DB 103. The registration motion “A” is a motion of operating (for example, determination of oil type and payment method) the display panel of the fuel filler 50. The registration motion “B” is a motion of touching the static elimination pad 53 with a hand. The registration motion “C” is a motion of removing the cap of the fuel filler hole 61 of the vehicle. The registration motion “D” is a motion of taking out the fuel filler nozzle (any one of 51a to 51c) from the attachment portion 52 of the fuel filler 50. The registration motion “E” is a motion of inserting the fuel filler nozzle into the fuel filler hole 61 of the vehicle. The registration motion “F” is a motion of gripping a trigger of the fuel filler nozzle (any one of 51a to 51c) to perform the fueling. The registration motion “G” is a motion of taking out the fuel filler nozzle from the fuel filler hole 61 of the vehicle and returning the fuel filler nozzle to the attachment portion 52 of the fuel filler. The registration motion “H” is a motion of closing a hole of the fuel filler hole 61 of the vehicle with a cap. These registration motion patterns may be stored as normal motion patterns associated with positions. Note that these registration motions are examples and are not limited thereto. Note that, in some example embodiments, attention motions may be registered. Examples of the attention motion include a posture or a motion of smoking in a gas station. Therefore, the attention motion may be registered in association with a specific position (for example, near the fuel filler nozzle) or may be registered in association with a wide region (for example, within the region of a gas station).

Returning to FIG. 7, the description will be continued. Next, the registration information acquisition unit 101 receives a sequence registration request including a plurality of registration motion IDs and information about the time-series order of each motion from the terminal device 200 (S34). Next, the registration unit 102 registers the registration motion sequence (the normal motion sequence NS or the attention motion sequence IS) in which the registration motion IDs are arranged based on the information about the time-series order in the motion sequence table 104 (S35). Then, the server 100 ends the processing.

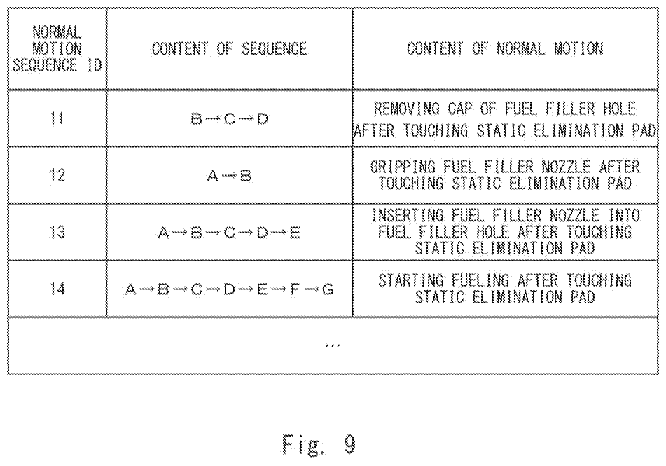

FIG. 9 is a diagram for describing the normal motion sequence NS according to the second example embodiment. As an example, the motion sequence table 104 may include at least four normal motion sequences NS having the normal motion sequence IDs of “11” to “14”. The normal motion sequence “11” is a sequence (B→C→D) including a motion of removing the cap of the fuel filler hole 61 after touching the static elimination pad 53. The normal motion sequence “12” is a sequence (A→B→D) including a motion of gripping the fuel filler nozzle 51 after touching the static elimination pad 53. The normal motion sequence “13” is a sequence (A→B→C→D→E) including a motion of inserting the fuel filler nozzle 51 into the fuel filler hole 61 after touching the static elimination pad 53. The normal motion sequence “14” is a sequence (A→B→C→D→E→F→G) including a motion of gripping the trigger of the fuel filler nozzle 51 after touching the static elimination pad 53 and starting the fueling.

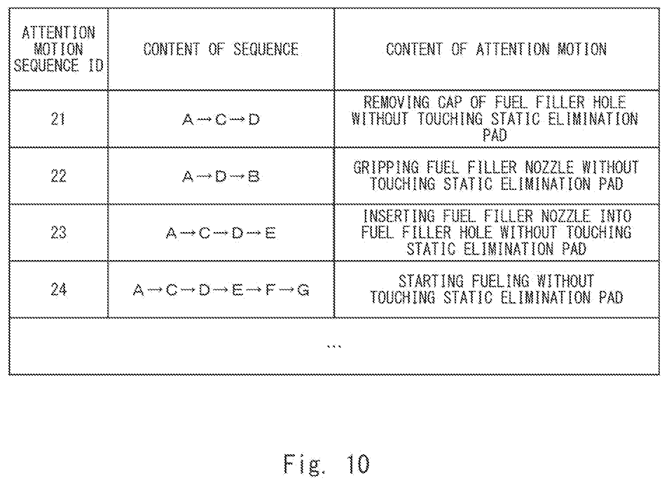

FIG. 10 is a diagram for describing the attention motion sequence IS according to the second example embodiment. The motion sequence table 104 may include at least two attention motion sequences IS having attention motion sequence IDs of “21” to “24”. The attention motion sequence “21” is a sequence (A→C→D) including a motion of removing the cap of the fuel filler hole of the vehicle without touching the static elimination pad. The attention motion sequence “22” is a sequence including a motion of gripping the fuel filler nozzle without touching the static elimination pad (A→D→B). The attention motion sequence “23” is a sequence including a motion of inserting the fuel filler nozzle into the fuel filler hole of the vehicle without touching the static elimination pad (A→C→D→E). The attention motion sequence “24” is a sequence including a motion of gripping the trigger of the fuel filler nozzle without touching the static elimination pad and starting the fueling (A→C→D→E→F→G).

The warning information may be set to be issued differently for each attention motion sequence illustrated in FIG. 10. For example, the sequence including the motion of gripping the trigger of the fuel filler nozzle and starting the fueling without touching the static elimination pad may indicate a higher danger level than the sequence including the motion of removing the cap of the fuel filler hole of the vehicle without touching the static elimination pad. Therefore, different warning information may be set to be issued in stages according to the danger level. Furthermore, the motion sequences illustrated in FIGS. 9 and 10 are merely examples, and various modifications are possible.

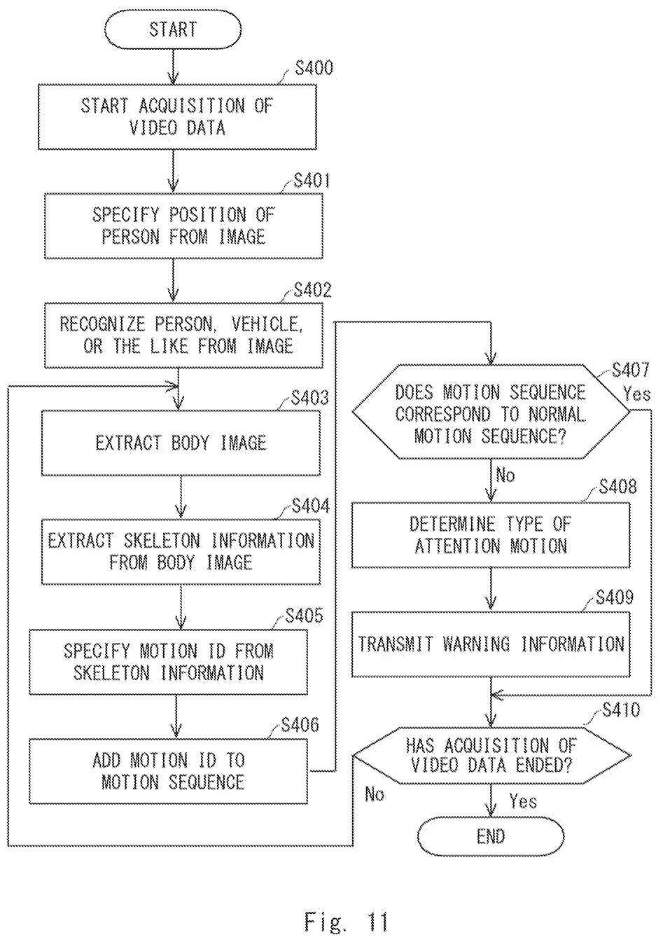

FIG. 11 is a flowchart illustrating a flow of the motion determination method by the server 100 according to the second example embodiment. First, the image acquisition unit 105 of the server 100 starts acquisition of video data from the terminal device 200 (S400). The position specifying unit 106 specifies the position of the person from the frame image included in the video data (S401). Furthermore, the target recognition unit 110 recognizes the person and the vehicle from the frame images included in the video data (S402), and stores the recognized person and vehicle in order to perform subsequent processing on the same person and vehicle. The extraction unit 107 extracts the body image from the frame image included in the video data (S403). Next, the extraction unit 107 extracts skeleton information from the body image (S404). The motion specifying unit 108 calculates a similarity between at least a part of the extracted skeleton information and each piece of registration skeleton information registered in the motion DB 103, and specifies a registration motion ID associated with registration skeleton information having a similarity equal to or more than a predetermined threshold as a motion ID (S405). Next, the generation unit 109 adds the motion ID to the motion sequence. Specifically, the generation unit 109 sets the motion ID specified in S405 as the motion sequence in the first cycle, and adds the motion ID specified in S405 to the already generated motion sequence in the next and subsequent cycles.

The determination unit 111 determines whether the motion sequence corresponds to any normal motion sequence NS in the motion sequence table 104 (S407). The determination unit 111 determines whether each unit motion corresponds to the normal motion sequence NS. In a case where the motion sequence corresponds to the normal motion sequence NS (Yes in S407), the determination unit 111 advances the processing to S410, and in a case where the motion sequence does not correspond to the normal motion sequence NS (No in S407), the determination unit advances the processing to S408.

The determination unit 111 determines which one of the attention motion sequences IS in the motion sequence table 104 the motion sequence corresponds to, thereby determining the type of the attention motion (S408). Then, the processing control unit 112 transmits warning information corresponding to the type of attention motion to the terminal device 200 (S409).

The server 100 determines whether the acquisition of the video data has ended (S410). When determining that the acquisition of the video data has ended (Yes in S410), the server 100 ends the processing. Meanwhile, when determining that the acquisition of the video data is not ended (No in S410), the server 100 returns the processing to S403 and repeats the addition processing of the motion sequence. By returning the processing to S403, it is possible to monitor the motion from the end of the fueling motion until the user U leaves the fuel filler 50.

As described above, according to the second example embodiment, the server 100 determines whether the motion of the user U is normal by comparing the motion sequence indicating the flow of the motion of the user U who has visited the fuel filler 50 with the normal motion sequence NS. As a result, by registering a plurality of normal motion sequences NS according to the flow of the operation using the fuel filler 50 in advance, it is possible to detect the attention motion according to the actual situation. Note that the second example embodiment also has the same effect as the first example embodiment.

A technique using general machine learning for acquiring and learning a video that is performing a normal motion and a video that is performing an abnormal motion is disclosed. In this method, a decrease in accuracy due to factors unrelated to motions such as background, clothes, belongings, and a capturing direction becomes a problem. As a result, versatility of the technology is low. Meanwhile, in the invention of the present application, the above problem is solved by using the posture information of the person and further using the feature amount robust to the direction of the person.

### Other Example Embodiments

In the above example embodiment, the server 100 and the terminal device 200 implement some functions in a distributed manner, but all the functions may be integrated. Furthermore, the camera 300 may include some or all of the functions of the server 100 and the terminal device 200 as an intelligent camera including a processor, a memory, and the like.

In the above example embodiment, the example of the gas station has been described, but the present invention can be applied to various applications. For example, it may be applicable in other situations where static electricity may be generated. For example, in the case of a taxi for a wheelchair, it may be applicable in a procedure in which a driver gets out of the taxi once and prepares a slope for the wheelchair. In addition, in the case of pay parking, it can be applied to guide a motion procedure in a checkout device.

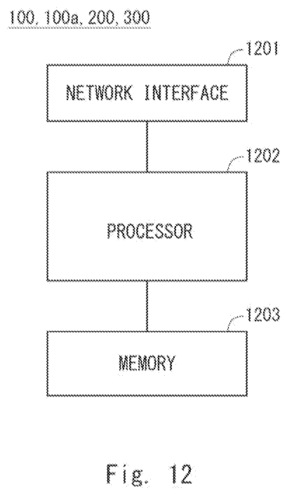

FIG. 12 is a block diagram illustrating a hardware configuration example of the motion determination apparatuses 100a and 100 and the terminal device 200 (hereinafter, referred to as a motion determination apparatus 100 or the like.) described in the above-described example embodiment. Referring to FIG. 12, the motion determination apparatus 100 or the like includes a processor 1201 and a memory 1202.

The processor 1201 reads and executes software (computer program) from the memory 1202, thereby performing processing of the motion determination apparatus 100 or the like described with reference to the flowchart in the above-described example embodiment. The processor 1201 may be, for example, a microprocessor, a micro processing unit (MPU), or a central processing unit (CPU). The processor 1201 may include a plurality of processors.

The memory 1202 is configured by a combination of a volatile memory and a nonvolatile memory. The memory 1202 may include a storage located away from the processor 1201. In this case, the processor 1201 may access the memory 1202 through an I/O interface (not illustrated).

In the example of FIG. 12, the memory 1202 is used to store a software module group. The processor 1201 can perform the processing of the motion determination apparatus 100 or the like described in the above-described example embodiment by reading and executing these software module groups from the memory 1202.

As described with reference to FIG. 2 or 11, each of the processors included in the motion determination apparatus 100 or the like executes one or a plurality of programs including a command group for causing a computer to perform the algorithm described with reference to the drawings.

In the above-described example embodiment, the configuration of the hardware has been described, but the present invention is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer readable medium or a tangible storage medium. By way of example, and not limitation, a computer-readable medium or tangible storage medium include random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage, or other magnetic storage devices. The program may be transmitted on a transitory computer readable medium or a communication medium. By way of example, and not limitation, the transitory computer readable medium or communication medium include electrical, optical, acoustic, or other forms of propagated signals.

Some or all of the above example embodiments may be described as the following Supplementary Notes, but are not limited to the following.

### Supplementary Note 1

A motion determination apparatus including:
a position specifying means for specifying a position of a person from acquired image data;
a motion specifying means for specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
a determination means for determining whether the specified characteristic motion is in a predetermined order.

### Supplementary Note 2

The motion determination apparatus according to Supplementary Note 1, further including a storage means for storing the predetermined order, a plurality of positions of the person, and a characteristic motion pattern performed by a person associated with the positions.

### Supplementary Note 3

The motion determination apparatus according to Supplementary Note 2, in which the plurality of positions is associated with a plurality of regions in an image.

### Supplementary Note 4

The motion determination apparatus according to any one of Supplementary Notes 1 to 3, in which the motion specifying means sets a feature point and a pseudo skeleton of a body of the person based on the image data.

### Supplementary Note 5

The motion determination apparatus according to any one of Supplementary Notes 1 to 4, in which the motion specifying means recognizes a motion of the body of the person in time series based on a plurality of consecutive image frames.

### Supplementary Note 6

The motion determination apparatus according to Supplementary Note 2, in which the storage means stores the characteristic motion pattern based on a plurality of consecutive image frames.

### Supplementary Note 7

The motion determination apparatus according to Supplementary Note 3, in which the storage means stores each of the regions defined as ranges adjacent to or separated from each other in the image, and stores each posture in which a hand of the person is present at a position approximate to the region as the characteristic motion pattern.

### Supplementary Note 8

The motion determination apparatus according to any one of Supplementary Notes 1 to 7, further including a target recognition means for recognizing a target,
in which the motion specifying means specifies a plurality of the characteristic motions for the same target recognized by the target recognition means.

### Supplementary Note 9

The motion determination apparatus according to any one of Supplementary Notes 1 to 8, further including an output means for outputting a determination result related to the determination,
in which the determination means sequentially determines a unit characteristic motion of each step in the predetermined order, and the output means sequentially outputs a determination result regarding each step.

### Supplementary Note 10

The motion determination apparatus according to Supplementary Note 2, in which
the storage means stores a time limit of each step in the predetermined order, and the determination means determines whether the time limit is exceeded in each step, and
the motion determination apparatus further includes an output means for outputting a determination result at a time point when the time limit is exceeded.

### Supplementary Note 11

The motion determination apparatus according to Supplementary Note 2, in which
the storage means further stores an attention motion pattern, the motion specifying means specifies an attention motion of the person according to the attention motion pattern,
the determination means determines that an attention state is established when the attention motion is specified regardless of the order, and
the motion determination apparatus further includes an output means for outputting attention information indicating the attention state.

### Supplementary Note 12

The motion determination apparatus according to any one of Supplementary Notes 1 to 11, further including a target recognition means for recognizing a vehicle present in a predetermined stop region in the image data,
in which when the target recognition means recognizes that the vehicle is stopped at a predetermined position, the motion specifying means specifies that the person has performed the characteristic motion.

### Supplementary Note 13

The motion determination apparatus according to any one of Supplementary Notes 1 to 12, further including a target recognition means for recognizing a vehicle present in a predetermined stop region in the image data,
in which when the target recognition means recognizes that the vehicle is stopped at a stop position, the determination means starts the determination.

### Supplementary Note 14

The motion determination apparatus according to any one of Supplementary Notes 1 to 12, further including a target recognition means for recognizing a fuel filler nozzle,
in which the determination means determines whether the fuel filler nozzle is inserted into a fuel filler hole of a vehicle.

### Supplementary Note 15

A motion determination method including:
specifying a position of a person from acquired image data;
specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
determining whether the specified characteristic motion is in a predetermined order.

### Supplementary Note 16

A non-transitory computer readable medium storing a program for causing a computer to execute:
a process of specifying a position of a person from acquired image data;
a process of specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
a process of determining whether the specified characteristic motion is in a predetermined order.

### REFERENCE SIGNS LIST

1 MOTION DETERMINATION SYSTEM
50 FUEL FILLER
51 FUEL FILLER NOZZLE
52 ATTACHMENT PORTION
53 STATIC ELIMINATION PAD
55 DISPLAY PANEL
60 VEHICLE
61 FUEL FILLER HOLE
100 SERVER
100a MOTION DETERMINATION APPARATUS
101 REGISTRATION INFORMATION ACQUISITION UNIT
102 REGISTRATION UNIT
103 MOTION DB
104 MOTION SEQUENCE TABLE
105 IMAGE ACQUISITION UNIT
106, 106a POSITION SPECIFYING UNIT
107 EXTRACTION UNIT
108, 108a MOTION SPECIFYING UNIT
109 GENERATION UNIT
110 TARGET RECOGNITION UNIT
111, 111a DETERMINATION UNIT
112 PROCESSING CONTROL UNIT
200 TERMINAL DEVICE
201 COMMUNICATION UNIT
202 CONTROL UNIT
203 DISPLAY UNIT
204 VOICE OUTPUT UNIT
300 CAMERA
IMG400 FRAME IMAGE
N NETWORK

What is claimed is:

1. A motion determination apparatus comprising:
at least one memory storing instructions, and
at least one processor configured to execute the instructions to;
specify a position of a person from acquired image data;
specify a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
determine whether the specified characteristic motion is in a predetermined order.

2. The motion determination apparatus according to claim 1, further comprising a storage for storing the predetermined order, a plurality of positions of the person, and a characteristic motion pattern performed by a person associated with the positions.

3. The motion determination apparatus according to claim 2, wherein the plurality of positions is associated with a plurality of regions in an image.

4. The motion determination apparatus according to claim 1, wherein the at least one processor is configured to execute the instructions to set a feature point and a pseudo skeleton of a body of the person based on the image data.

5. The motion determination apparatus according to claim 1, wherein the at least one processor is configured to execute the instructions to recognize a motion of the body of the person in time series based on a plurality of consecutive image frames.

6. The motion determination apparatus according to claim 2, wherein the storage stores the characteristic motion pattern based on a plurality of consecutive image frames.

7. The motion determination apparatus according to claim 3, wherein the storage stores each of the regions defined as ranges adjacent to or separated from each other in the image, and stores each posture in which a hand of the person is present at a position approximate to the region as the characteristic motion pattern.

8. The motion determination apparatus according to claim 1, wherein the at least one processor is configured to execute the instructions to recognize a target,
specify a plurality of the characteristic motions for the same target recognized.

9. The motion determination apparatus according to claim 1, wherein the at least one processor is configured to execute the instructions to output a determination result related to the determination,
sequentially determine a unit characteristic motion of each step in the predetermined order, and the output means sequentially outputs a determination result regarding each step.

10. The motion determination apparatus according to claim 2, wherein
the storage stores a time limit of each step in the predetermined order, and the at least one processor is configured to execute the instructions to determine whether the time limit is exceeded in each step, and
output a determination result at a time point when the time limit is exceeded.

11. The motion determination apparatus according to claim 2, wherein
the storage further stores an attention motion pattern, the at least one processor is configured to execute the instructions to specify an attention motion of the person according to the attention motion pattern,
determine that an attention state is established when the attention motion is specified regardless of the order, and
output attention information indicating the attention state.

12. The motion determination apparatus according to claim 1, wherein the at least one processor is configured to execute the instructions to recognize a vehicle present in a predetermined stop region in the image data,
recognize that the vehicle is stopped at a predetermined position, and specify that the person has performed the characteristic motion.

13. The motion determination apparatus according to claim 1, wherein the at least one processor is configured to execute the instructions to recognize a vehicle present in a predetermined stop region in the image data,
wherein, when it is recognized that the vehicle is stopped at a stop position, the at least one processor is configured to execute the instructions to start the determination.

14. The motion determination apparatus according to claim 1, wherein the at least one processor is configured to execute the instructions to recognize a fuel filler nozzle,
determine whether the fuel filler nozzle is inserted into a fuel filler hole of a vehicle.

15. A motion determination method comprising:
specifying a position of a person from acquired image data;
specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
determining whether the specified characteristic motion is in a predetermined order.

16. A non-transitory computer readable medium storing a program for causing a computer to execute:
a process of specifying a position of a person from acquired image data;
a process of specifying a first characteristic motion by analyzing a motion of the person in the image data in accordance with a first characteristic motion pattern associated with a first position of the specified person, and specifying a second characteristic motion by analyzing a motion of the person in the image data in accordance with a second characteristic motion pattern associated with a second position of the specified person; and
a process of determining whether the specified characteristic motion is in a predetermined order.
